(19) United States
(12) Patent Application Publication
(10) Pub. No.: US 2007/0097358 A1
(43) Pub. Date: May 3, 2007

(54) System and method for obtaining multi-color optical intensity feedback

(76) Inventors: Chin Hin Oon, Penang (MY); Boon Keat Tan, Loveland, CO (US); Eit Thian Yap, Loveland, CO (US)

Correspondence Address: AVAGO TECHNOLOGIES, LTD., P.O. BOX 1920, DENVER, CO, 80201-1920, US

(21) Appl. No.: 11/264,474

(22) Filed: Nov. 1, 2005

(51) Int. Cl. G01J 1/42

(52) U.S. Cl. 356/218

(57) ABSTRACT

In LED back-lighted display systems where the LED driving signals are pulse width modulated, brightness of the LED is determined by the duty cycle (length of the “on” pulse). In such systems, it is possible to, from time to time, skip an LED driving pulse without the human eye detecting the absence of (or change in) color during the “skipped” LED pulse. Using this approach, it is possible to measure the intensity of the light output from each LED of a multi-color LED display. Thus, in an embodiment having three colors, such as red, green and blue, it is possible to determine the light intensity from one of the LEDs (for example, the red LED) by skipping (blanking) the input driving pulses to the green and blue LEDs at a particular point in time. During that point in time the only light coming from the display would come from the unblanked LED which, in this case would be the red LED. It is then possible to measure the intensity of the red LED light using a photosensor without use of a filter. In similar manner, and at some later point in time, the light intensity from each of the other color LEDs can be measured using the same photosensor without using a filter. By spacing the blanking periods properly, the resulting change in color of the display will not be perceived by the human eye.

### TECHNICAL FIELD

This invention relates to optical systems and more particularly to such systems where it is desired to determine multi-color optical intensity, and even more particularly to such systems in which the determined intensity levels for each color are used in a feedback system.

### BACKGROUND OF THE INVENTION

Multi-color systems, such as are used for back-lighted displays, usually employ a tricolor system having red, green and blue light emitting diodes (LEDs) which can be mixed together to form a gamut of color. By proper stimulation, the LEDs can form white light as part of the gamut. Because the light intensity from each color LED is different, and because the intensity from each color can change differently over time it is often necessary to measure intensity during the operation of a display so as to be able to calibrate the resultant “mixed” color.

One method for determining light intensity from a multi-colored display is to place a photosensor in front of the display and measure the magnitude of the resultant output signal from the photosensor. In such a system, a filter can be placed between the display and the measuring photosensor so as to measure light intensity from only a specific LED. By selecting the filter properties, the light intensity from different colored LEDs can be measured. Such a system is cumbersome and not be readily adapted for use on a continuing basis for adjusting the LED driving signals in real time.

### BRIEF SUMMARY OF THE INVENTION

In LED back-lighted display systems where the LED driving signals are pulse width modulated, brightness of the LED is determined by the duty cycle (length of the “on” pulse). In such systems, it is possible to, from time to time, skip an LED driving pulse without the human eye detecting the absence of (or change in) color during the “skipped” LED pulse. Using this approach, it is possible to measure the intensity of the light output from each LED of a multi-color LED display. Thus, in an embodiment having three colors, such as red, green and blue, it is possible to determine the light intensity from one of the LEDs (for example, the red LED) by skipping (blanking) the input driving pulses to the green and blue LEDs at a particular point in time. During that point in time the only light coming from the display would come from the unblanked LED which, in this case would be the red LED. It is then possible to measure the intensity of the red LED light using a photosensor without use of a filter. In similar manner, and at some later point in time, the light intensity from each of the other color LEDs can be measured using the same photosensor without using a filter. By spacing the blanking periods properly, the resulting change in color of the display will not be perceived by the human eye.

### BRIEF DESCRIPTION OF THE DRAWINGS

For a more complete understanding of the present invention, reference is now made to the following descriptions taken in conjunction with the accompanying drawings, in which:

FIG. 1 shows one embodiment of a back-lighted device having colored LEDs grouped into pixels;

FIG. 2 shows one embodiment of a chart of timed power pulses and blanked pulses for light intensity measurement; and

FIG. 3 shows one embodiment of a process for determining brightness of an LED or group of LEDs.

### DETAILED DESCRIPTION OF THE INVENTION

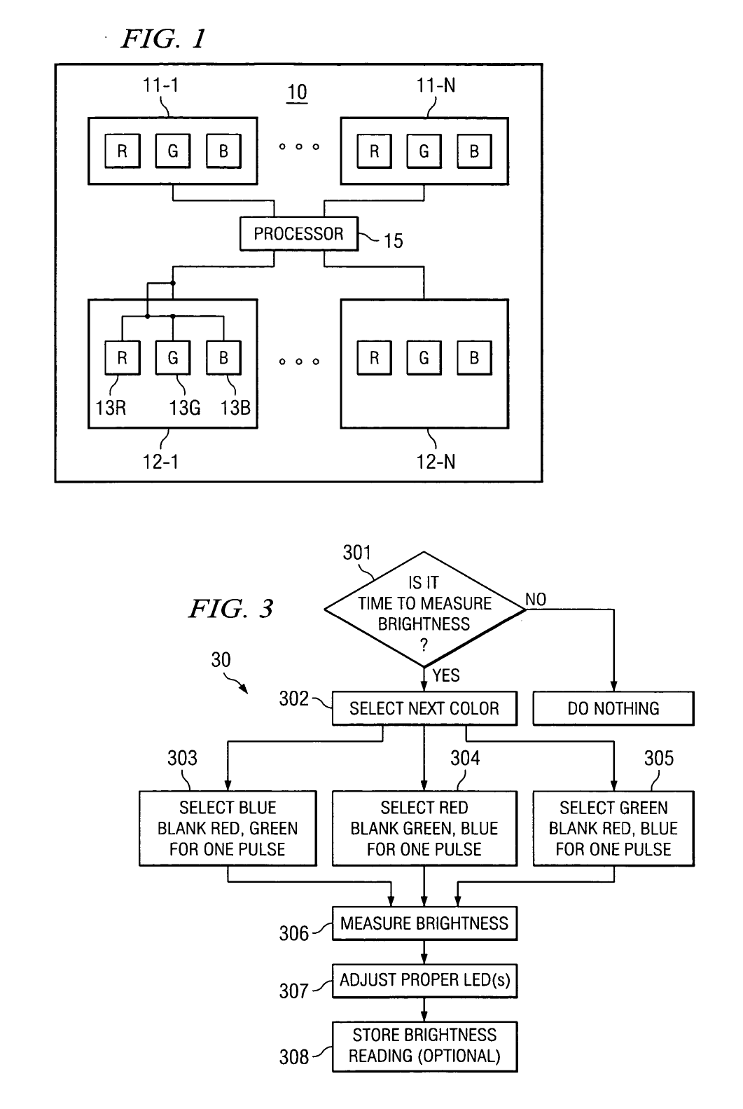

FIG. 1 shows one embodiment of a back-lighted device 10 having therein a plurality of red, green, blue LEDs, such as LEDs 13R, 13G, 13B, grouped into pixels to produce a color gamut depending upon the relative intensity of the individual LEDs. Associated with each grouping of LEDs is a sensor, such as sensor 12-1 through 12-N, 11-1 through 11-N. Each of the sensors can be, for example, a photodiode which measures the light intensity from the LEDs at that point. Note that while individual photosensors are shown for each group of LEDs a single photosensor could be utilized for the whole display if desired. Device 10 is controlled by processor 15 which creates the control for the light pulses in the manner to be discussed hereinafter.

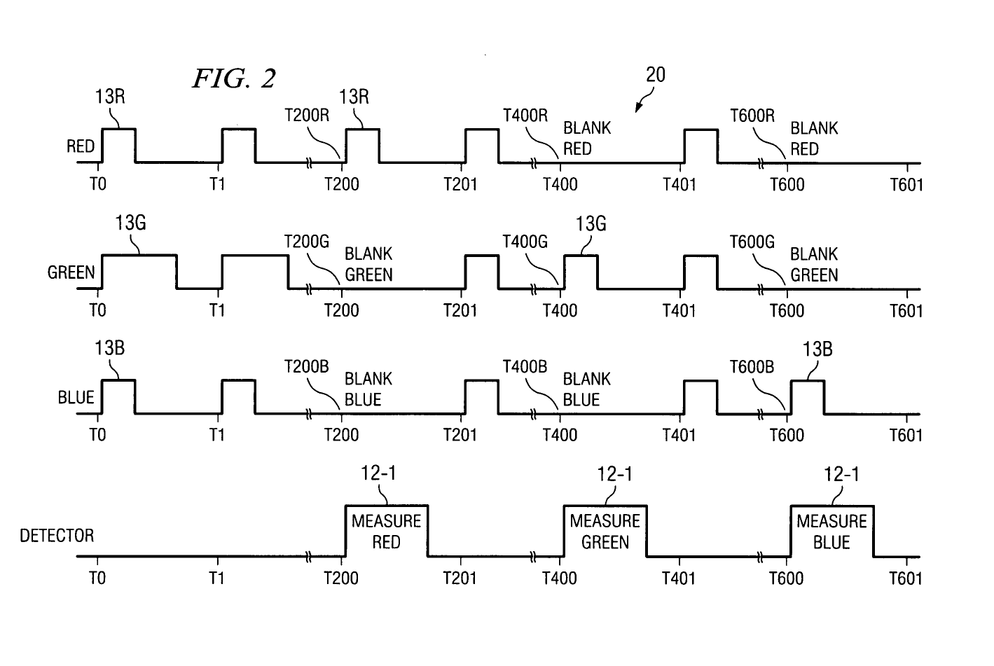

FIG. 2 shows one embodiment 20 of a chart having individual lines and power pulses for the red, green, and blue LEDs and a line for common detector 12-1. Note that with respect to FIG. 2 only one grouping of red, green and blue LEDs are portrayed and the system discussed herein can be used simultaneously for all of the groupings for a display or can be used one at a time if desired.

The horizontal axis is time, starting at time T0 and continuing with T1, T2 etc., all the way out as shown on the graph to T601. These time spaces can be, for example, 1 millisecond apart. Thus, as shown at time T0, there is a power pulse in the red LED that turns on LED 13R. At time T0, there is also a longer power pulse to turn on green LED 13G and a power pulse to turn on blue LED 13B. Note that the power pulse for LED 13G is longer than the power pulses for LEDs 13R and 13B because green requires more brightness with respect to red and blue in order to make a color white by blending all three colors.

At time T=1, the pulses repeat and this repetition continues for a period of time with the various pulses going on or off so as to adjust the relative color desired at any one point in time.

At time T200, which, for example, can be 200 milliseconds after T0, the pulses for the green and blue are blanked and only the pulse for the red LED 13R is on. This is shown at point T200R while points T200G and T200B are blank. Thus, at time T200 the only light that comes on is the red light from LED 13R. Sensor 12-1 at time T200 is turned on and this sensor measures red light because it is the only light available at that time. Thus sensor 12-1 measures the light intensity without a filter since the system knows that at time T200 only the red light is on.

At time T201 all pulses continue in the normal fashion until time T400 where the red and blue pulses are blanked, as shown at points T400R and T400B. At time T400, the only LED receiving power is LED 13G and thus detector 12-1 measures the green color intensity at time T400 again without a filter.

At time T401, all three LEDs are available to receive power which continues until time T600, where as shown at T600R and T600G, both red and green LEDs power inputs are blanked leaving power only to blue LED 13B. Thus, detector 12-1 at time T600 can only measure blue light intensity. Note that in the chart only three colors have been illustrated, but any number of different colors, can be measured in this fashion. Also note that the time spaces between the blinked pulses is a fixed time and the time pulses there between are evenly spaced. This need not be the case and, in fact, different spacing can be utilized from time to time, provided that they are spaced far enough apart so that the human eye will not detect the missing pulses. This minimum time space is approximately 10 milliseconds.

Also note that while only one cycle is shown in FIG. 2 the pattern continues for as long as desired. Thus, the blanking pattern can continue indefinitely in this manner or can be run on a schedule, say each hour or each half day, such that the measurement is then designed to determine deterioration over a longer period of time as opposed to measuring changes on a relatively short basis.

FIG. 3 shows one embodiment 30 of a process for determining brightness of an LED or group of LEDs. This process would be run, for example, by processor 15, FIG. 1 and would begin with process 301 determining that it is time to measure the brightness of one or more of the LEDs. If it is time, (for example, T200 in FIG. 2) process 302 selects the next color to be monitored. Since, in our example, at time T200 red is being monitored, process 304 blanks the green and blue pulses. By the same token, as discussed above, if this were time T400 then process 305 would be activated and the red and blue pulses would be blanked whereas if this were time T600, process 303 would be activated and the red and green pulses would be blanked.

Process 306 then measures the brightness for the non-blanked pulse at the measuring time. Process 307, if desired, adjusts the proper LEDs intensity based on what the measurement level is and also, if desired, process 308 stores the new intensity reading. If desired, this transmitted intensity level is to a remote location for further processing.

Note that while multi-colored lights have been illustrated, the concepts taught herein can be used with multiple light sources having the same color, but placed in different locations. Thus, it would be possible to measure (and control) the brightness of one light segment while the other light segments are momentarily off.

Also note that while pulse width modulation is shown, the concepts discussed herein can be used with DC driven light. In such a situation, the DC would be broken into small time frames. When it is desired to measure a particular channel of light the other (different colors or different locations) light channels are blanked as discussed above.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for measuring light intensity of a multiple light source device, said method comprising:
blanking a light power to all but a first one of said light sources; and
measuring the intensity occurring during said blanking.

2. The method of claim 1 wherein said blanked light power is one pulse in a series of pulses.

3. The method of claim 2 wherein said blanking occurs repeatedly throughout said series of pulses.

4. The method of claim 1 wherein said light sources are located in different locations.

5. A method for measuring light intensity of each light source of a multi-colored light device, said method comprising:
blanking a light stimulation pulse to all but a first one of said light sources, and
measuring the intensity of the light emitted from said non-blanked first light source, said measuring occurring during said blanking.

6. The method of claim 5 wherein said blanked light stimulation pulse is one pulse in a series of pulses.

7. The method of claim 5 further comprising:
blanking a light stimulation pulse to all but a second one of said light sources, said blanking occurring at a point in time different from the time at which said light simulation pulse to said first one of said light source occurred; and
measuring the intensity of the light emanating from said non-blanked second light source, said measuring occurring during said last-mentioned blanking.

8. The method of claim 7 further comprising:
blanking a light stimulation pulse to all but a third one of said light sources, said blanking occurring at a point in time different from the times at which said light simulation pulse to said first and second ones of said light sources occurred; and
measuring the intensity of the light emanating from said non-blanked third light source, said measuring occurring during said last-mentioned blanking.

9. The method of claim 8 further comprising:
repeating said first, second and third light source blanking and said first, second and third light intensity measuring.

10. The method of claim 8 further comprising:
adjusting the intensity of individual ones of said light sources dependant, at least in part, on said first, second and third light intensity measuring.

11. A back-lighted display comprising:
a plurality of light sources, each light source containing multi-colored LEDs the light from which blend to form a gamut of colors depending upon the relative intensity of each color of said multi-colored LEDs, wherein said light intensity is, in turn, dependant upon the duty cycle of a supplied power pulse;
a processor for selectively blanking a power pulse to all but a first color of the LEDs; and
at least one unfiltered photo sensor for measuring the intensity of the light emitted from a particular light source during said blanking of said power pulse.

12. The display of claim 11 wherein said processor is further operable for selectively blanking at a different point in time the power pulse to all but a second color of the LEDs and wherein said unfiltered photo sensor is operative for measuring the intensity of the light emitted from said particular light source during said different point in time blanking of said power pulse.

13. The display of claim 12 wherein said processor is further operable for selectively blanking at a different point in time the power pulse to all but a third color of the LEDs and wherein said unfiltered photo sensor is operative for measuring the intensity of the light emitted from said particular light source during said different point in time blanking of said power pulse.

14. The display of claim 13 wherein said processor is further operable for adjusting the color intensity of said display based, at least in part, on said respective measuring.

15. The display of claim 14 wherein said selective blanking is repetitive at a rate sufficiently spaced apart such that any color disruption to said display is imperceptible to the human eye.

16. A method for controlling a display having pixels comprised of red, green and blue LEDs driven by adjustable length power pulses, said method comprising:
periodically blanking the power pulses controlling all of the blue and green LEDs and measuring the light intensity of the red LED during said blanking;
periodically blanking the power pulses controlling all of the blue and red LEDs and measuring the light intensity of the green LED during said blanking;
periodically blanking the power pulses controlling all of the red and green LEDs and measuring the light intensity of the blue LED during said blanking; and
adjusting the intensity of the red, green and blue LEDS of said display based upon said measured light intensities.

17. The method of claim 16 wherein the period of said periodically blanking is such that the human eye will not perceive a light intensity difference caused by said blanking.

18. A display having pixels comprised of red, green and blue LEDs driven by adjustable length power pulses, said display comprising:
means for periodically blanking the power pulses controlling all of the blue and green LEDs;
means for measuring the light intensity of the red LED during said blanking;
means for periodically blanking the power pulses controlling all of the blue and red LEDs,
means for measuring the light intensity of the green LED during said last-mentioned blanking;
periodically blanking the power pulses controlling all of the red and green LEDs,
means for measuring the light intensity of the blue LED during said last-mentioned blanking; and
means for adjusting the intensity of the red, green and blue LEDS of said display based upon said measured light intensities.

19. The display of claim 18 wherein the period of said periodically blanking is such that the human eye will not perceive a light intensity difference caused by said blanking.

20. The display of claim 18 wherein said adjusting means comprises means for controlling the length of said power pulses.
